(19) United States
(12) Patent Application Publication
(10) Pub. No.: US 2007/0259198 A1
(43) Pub. Date: Nov. 8, 2007

(54) Joining material for positioning brazing material, process for producing a honeycomb body, corresponding honeycomb body and motor vehicle having a honeycomb body

(75) Inventors: Kait Althofer, Wiehl (DE); Rolf Bruck, Bergisch Gladbach (DE)

Correspondence Address: LERNER GREENBERG STEMER LLP, P O BOX 2480, HOLLYWOOD, FL, 33022-2480, US

(73) Assignee: Emitec Gesellschaft fur Emissionstechnologie mbH

(21) Appl. No.: 11/810,079

(22) Filed: Jun. 4, 2007

Related U.S. Application Data
(63) Continuation of application No. PCT/EP2005/012631, filed on Nov. 25, 2005.

(30) Foreign Application Priority Data
Dec. 2, 2004 (DE) DE 102004058285.8

(51) Int. Cl. B32B 3/12; B32B 3/00; B01D 50/00; B23K 31/02; B01J 21/04; B22F 7/04

(52) U.S. Cl. 428/553; 428/607; 428/614; 428/593; 428/116; 502/527.22; 502/439; 422/180; 228/181; 228/190; 228/248.1; 29/890

(57) ABSTRACT

A joining material for positioning brazing material on at least one discrete joining region of an at least partially metallic surface, includes a brazing material formed discontinuously on a continuous carrier material. The joining material is advantageously used for the production of honeycomb bodies, since the joining material makes it easy to join adjacent layers of the honeycomb body only at discrete joining regions. In this way, it is possible to produce honeycomb bodies which are elastic and yet durable. A process for producing a honeycomb body, a corresponding honeycomb body and a motor vehicle having a honeycomb body, are also provided.

### CROSS-REFERENCE TO RELATED APPLICATIONS

This is a continuing application, under 35 U.S.C. § 120, of copending International Application No. PCT/EP2005/012631, filed Nov. 25, 2005, which designated the United States; this application also claims the priority, under 35 U.S.C. § 119, of German Patent Application DE 10 2004 058 285.8, filed Dec. 2, 2004; the prior applications are herewith incorporated by reference in their entirety.

### BACKGROUND OF THE INVENTION

### Field of the Invention

The present invention relates to a joining material for positioning brazing material on a metallic surface, a process for producing a honeycomb body using such a joining material, a corresponding honeycomb body and a motor vehicle having a corresponding honeycomb body. Such honeycomb bodies are preferably used in the exhaust system of automobiles, in particular as a catalyst carrier body or a filter body.

Honeycomb bodies are generally formed from ceramic material or as a metallic honeycomb structure. A distinction is drawn in particular between two typical forms of metallic honeycomb bodies. An early form, of which German Published, Non-Prosecuted Patent Application DE 29 02 779 A1, corresponding to U.S. Pat. No. 4,273,681, shows typical examples, is the helical form, in which substantially one smooth sheet-metal layer and one corrugated sheet-metal layer are placed on top of one another and wound helically. In a different form, the honeycomb body is built up from a multiplicity of alternately disposed smooth and corrugated or differently corrugated sheet-metal layers, with the sheet-metal layers initially forming one or more stacks, which are then intertwined with one another. In the process, the ends of all of the sheet-metal layers come to lie on the outer side and can be joined to a housing or tubular casing, resulting in the formation of numerous joints, which increase the durability of the honeycomb body. Typical examples of those forms are described in European Patent EP 0 245 737 B1, corresponding to U.S. Pat. Nos. 4,832,998, 4,803,189, 4,946,822 and 4,923,109 or International Application WO 90/03220, corresponding to U.S. Pat. Nos. 5,105,539 and 5,139,844.

If the honeycomb body is built up from metallic or at least partially metallic layers, technical joining has to be used to connect the layers to one another so as to obtain a durable honeycomb body. The preferred manner of producing the technical joining connection is by brazing. However, a sintering process or even welding may be used as well. Since high temperatures regularly occur in the exhaust system of a motor vehicle, honeycomb bodies are generally brazed at high temperatures, i.e. are subjected to what is known as a brazing or hard-soldering process. In the exhaust system, honeycomb bodies are exposed to high mechanical loads, which are caused on one hand by shocks in the automobile which are also transmitted to the honeycomb body, and on the other hand are thermally induced. The high temperatures of the exhaust-gas stream and the pulsating nature of the exhaust gas cause high mechanical stresses in the honeycomb body. In particular, in the case of honeycomb bodies which are used as a catalyst carrier body, those stresses are amplified even further by the fact that the reaction catalyzed by the catalyst applied to the catalyst carrier body is generally exothermic. Overall, a honeycomb body in the exhaust system is exposed to high thermal gradients and transients. That exposes the honeycomb body to high thermal deformation. If the honeycomb body is rigid, i.e. the layers are joined to adjacent layers in joining regions over the entire cross section and length of the honeycomb body, thermal fractures can easily occur, and for that reason a honeycomb body which is as flexible as possible, and therefore has the minimum possible number of joining locations between the layers, is desirable. On the other hand, an insufficient number of joining locations leads to the occurrence of fatigue fractures at a relatively early time.

Therefore, the aim is for the layers of honeycomb bodies to be joined to one another only at defined, discrete joining regions. For example, German Published, Non-Prosecuted Patent Application DE 103 38 360, corresponding to U.S. Patent Application Publication No. U.S. 2006/0162854, has disclosed a process in which a binder in droplet form is applied only to those locations of the layers which are subsequently to be joined to one another. After the layers have been wound or stacked and intertwined, brazing material in powder form is applied. A similar process is known from European Patent EP 0 422 000, corresponding to U.S. Patent Application Publication Nos. U.S. 2002/0129890 and U.S. 2001/0013390, in which the binder is applied by using a sponge and then pulverulent brazing material is introduced. It is also known from German Published, Non-Prosecuted Patent Application DE 37 11 626, corresponding to Japanese Patent Publication No. JP 63264149, to apply the brazing material by thermal spraying. In that case, discrete joining locations are achieved by the thermal spraying taking place through a corresponding mask. Furthermore, German Published, Non-Prosecuted Patent Application DE 33 12 944 A1 discloses that the offset application of brazing material to layers of a honeycomb body is advantageous for the thermal expansion properties.

All of the processes disclosed herein for the application of brazing material only in discrete joining regions are relatively complex, since suitable measures have to be implemented to ensure either that binder is applied only in certain regions of the layers or that a mask is correspondingly accurately positioned. It is also known to use brazing foil or brazing wire to form the brazed joints. Those in each case form continuous brazing materials which do not allow the formation of discrete joining regions.

### SUMMARY OF THE INVENTION:

is accordingly an object of the invention to provide a joining material for positioning brazing material, a process for producing a honeycomb body, a corresponding honeycomb body and a motor vehicle having a honeycomb body, which overcome the hereinafore-mentioned disadvantages of the heretofore-known products, processes and devices of this general type and in which the joining material allows discrete brazed joints to be formed between two metallic structures.

With the foregoing and other objects in view there is provided, in accordance with the invention, a joining material. The joining material comprises a continuous carrier material, and brazing material formed discontinuously on the continuous carrier material, for positioning the brazing material on at least one discrete joining region of an at least partially metallic surface.

A joining material of this type advantageously allows discrete regions of brazing material to be positioned on joining regions of metallic surfaces without, for example, a binder having to be applied prior to the application of a brazing material. In particular, a joining material of this type can be wound or shaped together with the metallic surfaces which are to be joined. For this purpose, it may be advantageous for the carrier material and/or the brazing material to be provided with binder which fixes the joining material to the surfaces to be joined and thus ensures that accurately defined joining regions of the metallic surfaces can be provided with brazing material and subsequently joined. The carrier material and/or the brazing material may have markings which facilitate positioning of the joining material.

The present invention for the first time proposes a continuous material which can be used to position brazing material in discontinuous regions. Continuous brazing materials, such as for example continuous brazing foil, do not allow targeted application of brazing material and therefore joining of discrete regions of the at least partially metallic surface that is to be brazed, whereas targeted application of brazing material to discrete regions by application of a binder followed by application of brazing material, is complex and requires a high degree of accuracy, in particular when producing honeycomb bodies. The joining material according to the invention advantageously facilitates the handling of the brazing material and simplifies the production of discrete joints between at least partially metallic surfaces. In the present context, an at least partially metallic surface is to be understood as meaning a surface which in particular has a metallic or partially metallic surface. A surface of this type may be formed by a sheet-metal layer, but also by a fibrous layer which may also include ceramic fibers. By way of example, an at least partially metallic surface can also be formed by a mat which has been woven from metal and ceramic fibers and can be used as a filter mat, for example in diesel particulate filters.

In accordance with another feature of the invention, the brazing material is at least partially in the form of a brazing foil.

In accordance with a further feature of the invention, the brazing material is at least partially in the form of brazing material grains.

It is particularly advantageous for the brazing material to be formed as a brazing foil if planar surfaces are to be joined to one another. Brazing foil also offers the advantage that in the event of deformation of the surfaces to be brazed, during which, for example, one surface slides along the other surface, the joining regions formed from brazing foil remain substantially undeformed or unmoved. Forming the brazing material from brazing material grains may be advantageous in particular if it is necessary to bend the joining material, for example through contact with a curved metallic surface. Moreover, forming the brazing material from brazing material grains allows it to be matched in particular, for example, to the thickness and shape of the surfaces to be brazed, since a different brazing material grain fraction is advantageous depending on the thickness and shape of the surfaces in order to ensure optimum attachment of the metallic surfaces.

In accordance with an added feature of the invention, the brazing material is fixed on the carrier material by using a first adhesive.

The first adhesive being used may, for example, be known organic adhesives or water-based adhesives. This first adhesive advantageously imparts good bonding between carrier material and brazing material, so that reliable and accurate positioning of the brazing material can be achieved by positioning the carrier material relative to the at least partially metallic surfaces that are to be brazed.

In accordance with an additional feature of the invention, the brazing material has a second adhesive on a side facing away from the carrier material.

This may be advantageous, in particular, if the brazing material is to be transferred to the metallic surface that is to be provided with brazing material by a rolling movement on the part of the joining material. For this purpose, the joining material is rolled longitudinally onto the at least partially metallic surface, so that the brazing material remains stuck to the surface by the second adhesive. The carrier material can then be easily pulled off the brazing material. The brazing material is therefore stuck to the at least partially metallic surface in a similar way to a label. In this context, it is particularly advantageous for a first adhesive force produced by the first adhesive to be greater than a second adhesive force produced by the second adhesive. It is also advantageous in this context for the brazing material to be in the form of a brazing foil, since in this case it is easy to apply the second adhesive.

In accordance with yet another feature of the invention, a third adhesive is formed on a side of the carrier material which faces away from the brazing material.

This third adhesive makes it easy to fix the joining material. In particular, in this way it is also possible to pre-fix the product that is to be brazed. Furthermore, providing the third adhesive advantageously increases the accuracy of positioning of the brazing material relative to the at least partially metallic surface that is to be brazed, since subsequent movement of the joining material relative to the surface is prevented.

In accordance with yet a further feature of the invention, the carrier material is formed from a metal, a plastic and/or paper, preferably a plastic and/or paper.

Metals and paper as well as plastics make it easy to produce and handle the joining material. Carrier materials which are known from the production of adhesive labels can advantageously be used. A plastic-coated paper can also be used as the carrier material according to the invention.

In accordance with yet an added feature of the invention, the carrier material has a critical temperature above which the support material is destroyed and which is less than or equal to the melting point of the brazing material. In this context, it is particularly preferable for the carrier material, when at least the critical temperature is reached, to be at least partially evaporated and/or at least partially decomposed, preferably to be evaporated substantially without leaving any residues and/or to be decomposed substantially without leaving any residues.

This advantageously ensures that the brazed end product preferably does not have any residues of the carrier material. Evaporation may occur, in particular, when the carrier material is at least partially formed from plastic. Combustion of the carrier material leaving virtually no residues is also possible in accordance with the invention.

With the objects of the invention in view, there is also provided a process for producing a honeycomb body having a honeycomb structure with cavities through which a fluid can at least partially flow. The process comprises at least the following steps:
A) at least providing an at least partially metallic layer;
B) positioning brazing material at least on joining regions of at least one of the layers;
C) forming the honeycomb structure from the at least one layer;
D) if appropriate, providing a tubular casing;
E) if appropriate, positioning brazing material at least on an attachment region of an outer surface of the honeycomb structure and/or an inner surface of the tubular casing;
F) if appropriate, introducing the honeycomb structure into the tubular casing; and
G) carrying out a brazing operation.

In step B) and/or step E), the brazing material is at least partially positioned in the form of a joining material according to the invention, and/or in step B) and/or step E), brazing material at least partially in the form of brazing foil is adhesively bonded to at least one joining region and/or at least one attachment region.

Therefore, the process according to the invention allows the production of a honeycomb body having at least partially metallic layers and only one honeycomb structure, as well as a honeycomb body having a honeycomb structure in a tubular casing, preferably a metallic tubular casing. In this case, the joining material according to the invention and/or the stuck-on brazing foil can be used both to form the joints in the honeycomb structure and to join the honeycomb structure to the tubular casing. A combination of any other desired brazing-application processes is possible in accordance with the invention. The brazing foil can be stuck on using known adhesives, for example water-based or organic-based adhesives. The process according to the invention for producing a honeycomb body for the first time allows the economically viable production of honeycomb bodies with offset brazed joints, as is described in German Published, Non-Prosecuted Patent Application DE 33 12 944 A1.

The honeycomb bodies produced in this way are particularly suitable for use in automotive engineering, in particular in the exhaust system of a motor vehicle, where a honeycomb body produced in accordance with the invention can be used, for example, as a catalyst carrier body, a filter body, an adsorber body and/or a muffler. Accordingly, the at least partially metallic layers can at least in part be formed as sheet-metal layers, fibrous layers, filter layers and/or composite layers. A composite layer is to be understood, for example, as a layer which includes both metallic and non-metallic fractions, for example a ceramic fiber layer which is held within a porous metal covering layer. Furthermore, in the context of the present invention, a layer may also include any desired combination of sublayers, for example a fiber layer reinforced with sheet-metal layer sections or the like. In particular, it is also possible to produce honeycomb bodies with large diameters, preferably of more than 150 mm (millimeters) by using the processes according to the invention. In the case of a honeycomb body which is not circular in cross section, the term diameter is to be understood as meaning a characteristic dimension of this cross section, for example a maximum, minimum or mean diameter.

The process according to the invention for producing a honeycomb body makes it possible, with simple and inexpensive positioning of the brazing material, for only defined, discrete joining regions of the layers to be joined to one another and/or defined, discrete joining regions between the honeycomb structure and tubular casing to be joined. In this way, it is possible to produce honeycomb bodies which are flexible. The flexibility may also, for example, be matched to the subsequent use, i.e. in particular to the expected exhaust-gas volumetric flows, the frequency of pulsation of these flows and the momenta of these flows. For example, it is advantageously possible to produce honeycomb bodies with increased durability. These honeycomb bodies can be produced in a simple and inexpensive way using the joining material according to the invention or by sticking on brazing foil. It is preferably possible for a plurality of joining regions to be formed on one layer, in particular also on both longitudinal sides of a layer.

In accordance with another mode of the invention, the brazing foil is cut to the dimensions of the joining region prior to or during process step B).

Therefore, the dimensions of the brazing foil after it has been cut correspond to the desired dimensions of the joining region.

In accordance with a further mode of the invention, the brazing foil is joined to a carrier material.

A brazing foil on a carrier material of this type can form a joining material as described above. However, in this case it is also possible for there to be a continuous brazing foil on carrier material, which is in each case cut according to the required dimensions of the joining regions. The continuous brazing foil may have desired breaking locations, which lead to it being cut to the desired dimensions.

In accordance with an added mode of the invention, at least one at least partially structured layer is provided in process step A).

In accordance with an additional mode of the invention, at least one substantially smooth layer is provided in process step A).

By way of example, it is possible to produce a honeycomb structure in which in process step C) at least one at least partially structured layer and if appropriate at least one substantially smooth layer are wound helically. The term substantially smooth layer is to be understood as meaning a layer which may be smooth but may also have micro-structuring, the structure amplitude of which is significantly smaller than that of the at least partially structured layer. Structuring is to be understood as encompassing in particular a corrugation, for example a sinusoidal, sawtooth and/or triangular corrugation. A structuring is preferably periodic, i.e. has a characteristic repetition length, such as for example a wavelength.

In process step C), a honeycomb structure can, for example, also be formed by at least one at least partially structured layer and if appropriate at least one substantially smooth layer being stacked to form at least one stack, and at least one stack being intertwined in the same direction or opposite directions.

Depending on the detailed construction of the layers, in this way it is possible to form honeycomb bodies which have a honeycomb structure with passages passing through the honeycomb structure in a longitudinal direction. It is also possible and in accordance with the invention to form a honeycomb structure with partially closed passages, with guide structures in the passage wall, with perforations, turbulence-inducing structures, etc.

In accordance with yet another mode of the invention, a structuring of the at least partially structured layer has a characteristic distance between two adjacent structure extremes, in particular a wavelength, in the transverse direction of the structuring, wherein at least some of the joining regions, in the transverse direction of the structuring, have an extent which is greater than the characteristic distance.

If the joining material or the brazing foil is applied to a smooth layer, i.e. the brazing material in process step B) or E) has been positioned on a substantially smooth layer, the preferred extent of the joining regions ensures that at least one structure extreme of the at least partially structured layer comes to bear against the joining region, where it is joined to the substantially smooth layer. In this context, it is particularly preferable for the quotient of the characteristic distance and the extent to be between substantially 1.2 and substantially 5, preferably between substantially 1.5 and substantially 3, and particularly preferably between substantially 1.8 and substantially 2.5.

In addition to the joining material being applied to a substantially smooth layer, it is also possible and in accordance with the invention for the joining material to be applied to an at least partially structured layer. A combination of these two forms of application in one honeycomb body is also possible and in accordance with the invention.

In accordance with yet a further mode of the invention, the dimensions of the carrier material of the joining material substantially at least partially correspond to the dimensions of at least one of the layers.

In the present context, the term at least partially correspond means that a dimension of the joining material substantially corresponds to a corresponding dimension of one of the layers, i.e. by way of example the joining material and a layer have the same length and/or width. This allows the positioning of the joining material and layer to be correspondingly oriented with respect to one another in a particularly simple way.

In accordance with yet an added mode of the invention, the joining material and/or the brazing material is fixed to the layer in process step B) or is fixed to the outer surface of the honeycomb structure and/or the inner surface of the tubular casing in process step E).

This fixing can be achieved through the use of corresponding adhesives on the carrier material and/or the brazing material. If the brazing material is fixed to the layer or the outer surface of the honeycomb structure and/or the inner surface of the tubular casing, the carrier material can be pulled off, so that it is no longer wound into the honeycomb body.

In accordance with yet an additional mode of the invention, before or during process step B) or E) an adhesive is applied to the brazing material and/or to the carrier material.

The application of adhesive to the brazing material and/or the carrier material allows the joining material, the brazing material and/or the brazing foil to be correspondingly fixed to the joining regions of the layers which are to be joined.

In accordance with still another mode of the invention, joining regions are formed on both longitudinal sides of a layer, and the layer in each case has a joining region on only one longitudinal side at a given coordinate.

The layer therefore does not have any point which has joining regions on both longitudinal sides. This makes it possible to construct honeycomb bodies with very good thermal expansion properties, since a honeycomb body composed of corresponding layers permits relative movements of the layers perpendicular to the longitudinal direction of the honeycomb body to a certain extent, without a brazed joint breaking.

In accordance with still a further mode of the invention, the joining regions are formed in such a way that at least two subregions, in which joining regions are produced, are formed in a longitudinal direction of the honeycomb body, and a layer on a longitudinal side only has joining regions in one subregion.

A honeycomb body produced in this way has good thermal expansion properties combined, at the same time, with a good durability. In particular, the offset joining regions also permit a relative movement of the individual layers in the longitudinal direction of the honeycomb body. The subregions are preferably formed on or adjacent end sides of the honeycomb body. As an alternative or in addition, it is possible and in accordance with the invention for a further, third subregion to be formed substantially in the longitudinal direction centrally within the honeycomb body. In this context, it is particularly advantageous if, in the first and second subregions, the joining regions are formed on a first longitudinal side of the layers, while in the third subregion the joining regions are formed on a second longitudinal side, which is the opposite side from the first longitudinal side. A concertina or accordion-like brazed configuration of this nature has proven particularly advantageous with regard to thermal expansion properties and durability.

With the objects of the invention in view, there is additionally provided a honeycomb body. The honeycomb body comprises a honeycomb structure having at least one at least partially metallic layer defining cavities through which a fluid can at least partially flow. Optionally, a tubular casing surrounds the honeycomb structure. Brazing material is positioned or adhesively bonded as a brazing foil in at least some of the joining regions by the joining material according to the invention. The at least one layer is brazed to at least one of itself or an adjacent layer only in joining regions and/or the at least one layer is brazed to the tubular casing only in attachment regions. The brazing material is positioned or adhesively bonded as the brazing foil in at least some of the attachment regions by the joining material.

In particular, the honeycomb body according to the invention may have been produced by the process according to the invention for producing a honeycomb body.

In accordance with another feature of the invention, the honeycomb body has a diameter of substantially greater than or equal to 150 mm (millimeters).

In accordance with a further feature of the invention, the honeycomb body includes at least one layer which has joining regions on both longitudinal sides, and the layer in each case has a joining region on only one longitudinal side at a given coordinate.

In accordance with an added feature of the invention, the joining regions are constructed in such a way that at least two subregions, in which joining regions are produced, are formed in a longitudinal direction of the honeycomb body, and a layer on a longitudinal side has joining regions only in one subregion.

In accordance with an additional feature of the invention, in each case a subregion is formed in the region of or adjacent an end side of the honeycomb body.

In accordance with yet another feature of the invention, a third subregion is formed substantially in the longitudinal direction centrally within the honeycomb body.

With the objects of the invention in view, there is concomitantly provided a motor vehicle, comprising at least one honeycomb body according to the invention or at least one honeycomb body produced by the process according to the invention.

In the present context, a motor vehicle is to be understood in particular as meaning a passenger automobile, a truck, a motorized two-wheeler, a quad bike, a boat or an aircraft.

Other features which are considered as characteristic for the invention are set forth in the appended claims.

Although the invention is illustrated and described herein as embodied in a joining material for positioning brazing material, a process for producing a honeycomb body, a corresponding honeycomb body and a motor vehicle having a honeycomb body, it is nevertheless not intended to be limited to the details shown, since various modifications and structural changes may be made therein without departing from the spirit of the invention and within the scope and range of equivalents of the claims.

The details and advantages which have been disclosed in connection with the joining material according to the invention, the processes according to the invention, the honeycomb body according to the invention and the motor vehicle according to the invention, can in each case alternatively also be applied and transferred to the others.

The construction and method of operation of the invention, however, together with additional objects and advantages thereof will be best understood from the following description of specific embodiments when read in connection with the accompanying drawings.

### BRIEF DESCRIPTION OF THE DRAWINGS:

FIG. 1 is a fragmentary, diagrammatic, plan view of a portion of a joining material according to the invention;

FIG. 2 is a fragmentary, cross-sectional view of a joining material according to the invention;

FIG. 3 is a reduced sectional view illustrating a process step used in the processes according to the invention for producing a honeycomb body;

FIG. 4 is an enlarged perspective view of a stack of a plurality of layers;

FIG. 5 is a cross-sectional view of a stack of a plurality of layers;

FIG. 6 is a cross-sectional view of a honeycomb body according to the invention;

FIG. 7 is a fragmentary, cross-sectional view of a honeycomb body according to the invention;

FIG. 8 is a plan view of a layer used to construct a honeycomb body according to the invention;

FIG. 9 is a side-elevational view of a layer used to construct a honeycomb body according to the invention; and

FIG. 10 is a longitudinal-sectional view of a portion of a honeycomb body according to the invention.

### DESCRIPTION OF THE PREFERRED EMBODIMENTS:

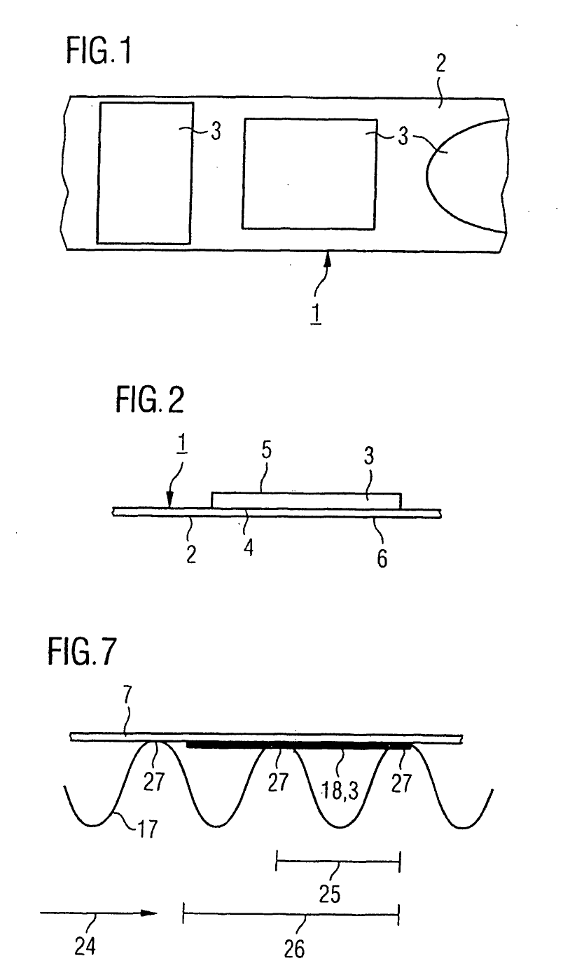

Referring now to the figures of the drawings in detail and first, particularly, to FIG. 1 thereof, there is seen a diagrammatically illustrated plan view of a portion of a joining material 1 according to the invention. The joining material 1 includes a carrier material 2 and a brazing material 3, which is formed discontinuously on the carrier material 2. The brazing material 3 may preferably be in the form of a brazing foil or brazing material powder, but particularly preferably brazing foil. The regions of brazing material 3 may take various shapes and sizes.

FIG. 2 diagrammatically depicts a cross section through a portion of a joining material 1 according to the invention. The brazing material 3 is fixed on the carrier material 2 through the use of a layer of a first adhesive 4. A layer of a second adhesive 5, by which the brazing material can be fixed on an at least partially metallic surface, is formed on a side which faces away from the carrier material 2. This fixing can be accomplished, for example, in a similar way to sticking on a label. As an alternative and/or in addition, it is possible for a third adhesive 6 to be formed on a side of the carrier material 2 which faces away from the brazing material 3. The carrier material 2 is fixed on a surface, in particular an at least partially metallic surface, which is to be provided with brazing material, through the use of the third adhesive 6.

The adhesives 4, 5, 6 are selected in such a way that the adhesive forces allow accurate positioning of the brazing material 3 on the corresponding surfaces. In particular, the first adhesive 4 produces a first adhesive force between the carrier material 2, the first adhesive 4 and the brazing material 3. The second adhesive 5 produces a second adhesive force between the brazing material 3, the second adhesive 5 and the surface to which brazing material is to be applied.

The forces are matched to one another in such a way that the brazing material 3 is stuck onto the corresponding surface that is to be provided with brazing material while at the same time the brazing material 3 is detached from the carrier material 2.

The carrier material 2 is preferably formed of plastic and/or paper. In particular, it is preferable for the carrier material 2 to be formed of a substance which, at a crystal temperature that is lower than the brazing temperature of the brazing material 3, evaporates as far as possible without leaving any residues or decomposes as far as possible without leaving any residues.

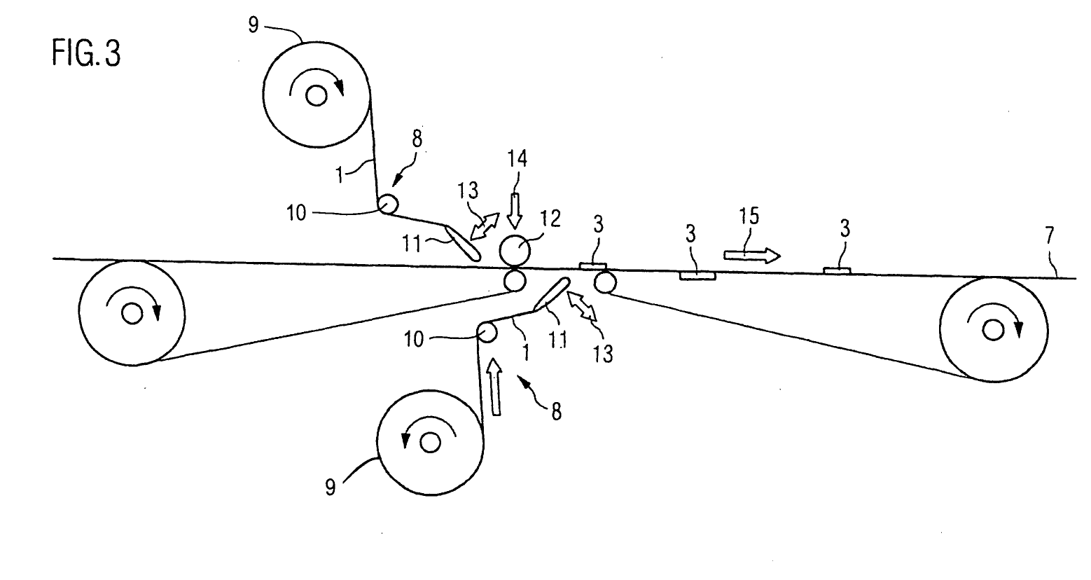

FIG. 3 diagrammatically depicts a process step B) of one of the processes according to the invention for producing a honeycomb body. The figure shows, by way of example, how brazing material 3 is applied to a substantially smooth layer 7. Two brazing application units 8 are provided for this purpose. These units each include a stock reel 9 of joining material 1, corresponding guide rolls 10 and applicators 11.

The applicators 11 press the individual regions of brazing material 3, which have been provided with a second non-illustrated adhesive 5, onto the substantially smooth layer 7 at predeterminable positions, through movement in an application direction 13, so that corresponding joining regions of the substantially smooth layer 7 are provided with the brazing material 3. If appropriate, it is possible to provide a pressure-exerting roll 12, by which the brazing material 3 is subsequently fixed by applying pressure in a pressing direction 14. The removal of the used carrier material 2 is not illustrated, for the sake of clarity. The substantially smooth layer 7 is moved in a direction of movement 15.

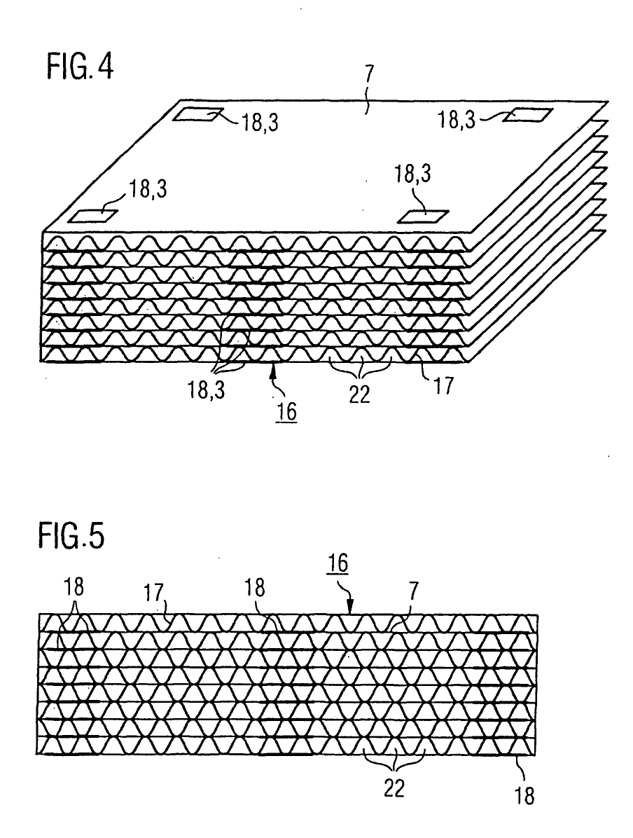

FIG. 4 diagrammatically illustrates a stack 16 of a plurality of substantially smooth layers 7 and at least partially structured layers 17, which form passages 22. The substantially smooth layers 7 have joining regions 18, in which brazing material 3 has been applied to the smooth layer 7. In the present example, each substantially smooth layer 7 has four joining regions 18 on a first longitudinal side in an edge region of the layer 7, and two substantially centrally located joining regions 18 on an opposite, second longitudinal side of the layer 7. FIG. 5 shows a cross section through the stack shown in FIG. 4.

FIG. 6 diagrammatically depicts a cross section through a honeycomb body 19 according to the invention. The honeycomb body 19 includes a honeycomb structure 20, which is disposed in a tubular casing 21. The honeycomb structure 20 has been formed by folding over and then intertwining three stacks 16. The at least partially structured layers 17 have not been illustrated, for the sake of clarity.

The intertwining operation produces the illustrated pattern of joining regions 18, which are illustrated as small circles. This type of configuration of the joining regions advantageously leads to an elastic, durable honeycomb body 19, which can be used in particular as a catalyst carrier body or filter body in the exhaust system of a motor vehicle. The honeycomb structure 20 is fixed to the tubular casing 21 by way of attachment regions 23 which have been positioned by using a joining material 1 according to the invention.

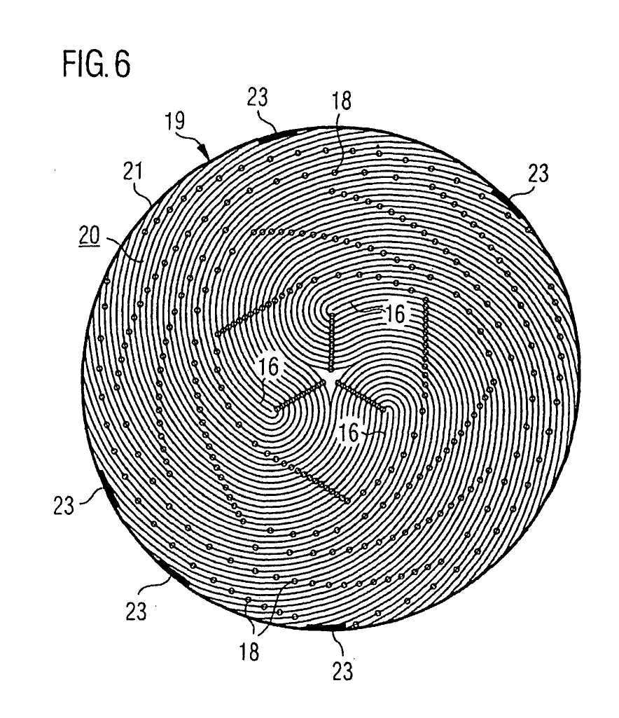

FIG. 7 diagrammatically illustrates a portion of a honeycomb body 19 according to the invention. A substantially smooth layer 7 has been joined to an at least partially structured layer 17 through the use of a joining region 18 formed by brazing material 3. The at least partially structured layer 17 is corrugated, so that in a transverse direction 24 of the structuring it has a characteristic distance or wavelength 25, i.e. a distance between two structure maxima 27. The joining region 18 has an extent 26 in the transverse direction 24 which is greater than the wavelength 25.

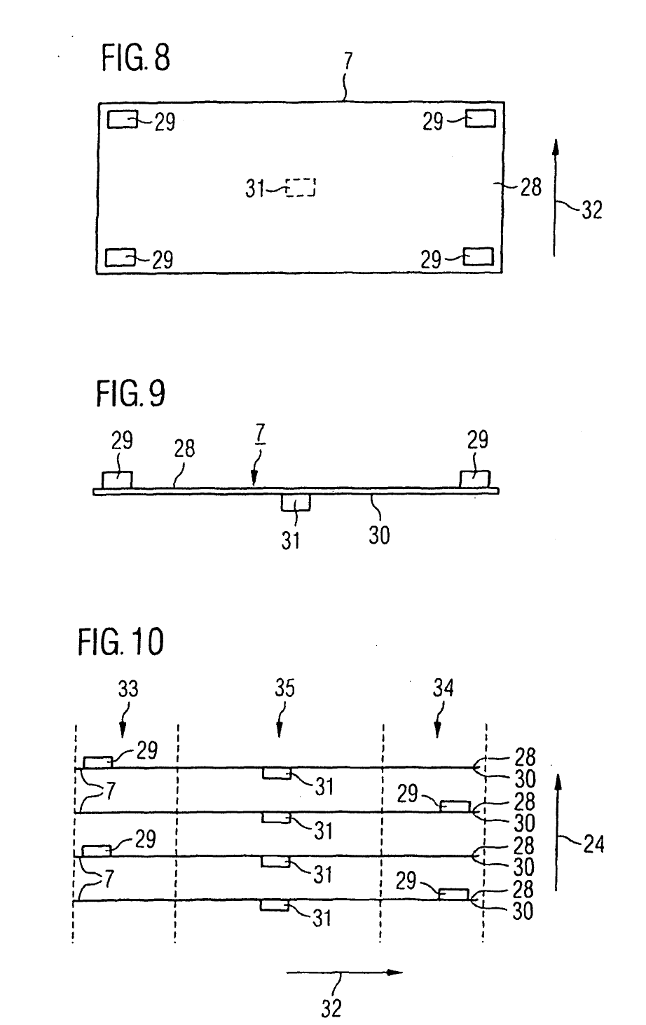

FIG. 8 diagrammatically depicts a substantially smooth layer 7 used to construct a honeycomb body 19 according to the invention, which is shown in a plan view onto a first longitudinal side 28. First joining regions 29 are formed on the first longitudinal side 28, while a second joining region 31 is formed on a second longitudinal side 30 (see FIG. 9). This second joining region 31 is indicated by dashed lines, to demonstrate that it is formed on the second longitudinal side 30. The substantially smooth layer 7 does not have any location at which joining regions 29, 31 are formed on both longitudinal sides 28, 30. Therefore, there are no joining regions 29, 31 lying opposite each other at the same location of the layer 7. A corresponding construction of the joining regions 29, 31 is likewise possible, in accordance with the invention, on an at least partially structured layer 17. The number and location of the joining regions 29, 31 is to be understood to be purely as an example. Furthermore, FIG. 8 shows a subsequent longitudinal direction 32 of the honeycomb body 19.

FIG. 9 shows a side view of the substantially smooth layer 7 shown in FIG. 8. The first joining regions 29 have been formed on the first longitudinal side 28, while the second joining region 31 has been formed on the second longitudinal side 30.

FIG. 10 diagrammatically illustrates a longitudinal section through a portion of a honeycomb body 19 according to the invention. The at least partially structured layers 17, which are located between the illustrated substantially smooth layers 7, are not illustrated for the sake of clarity. First joining regions 29 and second joining regions 31 are diagrammatically indicated in the drawing. The first joining regions 29 are in each case formed on the first longitudinal side 28 of the substantially smooth layers 7, while the second joining regions 31 are in each case formed on the second longitudinal side 30 of the substantially smooth layers 7. In the joining regions 29, 31, the substantially smooth layer 7 is joined to adjacent, at least partially structured layers 17. The joining regions 29, 31 are formed by brazing material 3 which is positioned through the use of the joining material 1 according to the invention or formed by stuck-on brazing foil.

A first subregion 33, a second subregion 34 and a third subregion 35 are formed in a longitudinal direction 32 of the honeycomb body 19, through which a medium can at least partially flow in the non-illustrated passages 22. The first joining regions 29 are in each case constructed in such a way that the first longitudinal side 28 of an individual layer 7 only has first joining regions 29 on the first longitudinal side 28 of the substantially smooth layer 7. The first joining regions 29 of a layer 7 therefore belong either to the first subregion 33 or to the second subregion 34.

Consequently, there is preferably no layer 7 which has first joining regions 29 in the first subregion 33 and in the second subregion 34.

The first subregion 33 and the second subregion 34 are preferably in the vicinity of or adjacent an end side of the honeycomb body 19. The third subregion 35 lies substantially centrally with respect to the extent of the honeycomb body 19 and/or the layers 7.

A honeycomb body 19 constructed as shown in FIG. 10 has very good thermal expansion properties, since a relative movement of the individual layers 7, 17 with respect to one another, for example caused by thermal expansion properties of the layers 7, 17, is possible to a certain extent both in the longitudinal direction 32 and in a transverse direction 24. At the same time, a honeycomb body 19 of this type has a very good durability.

The joining material 1 according to the invention can particularly advantageously be used for the production of honeycomb bodies 19, since adjacent layers 7, 17 of the honeycomb body 19 can be joined only in discrete joining regions 18 through the use of the joining material 1, in a simple way. In this way it is possible to produce honeycomb bodies 19 which are elastic and yet durable.

We claim:

1. A joining material, comprising:
a continuous carrier material; and
brazing material formed discontinuously on said continuous carrier material, for positioning said brazing material on at least one discrete joining region of an at least partially metallic surface.

2. The joining material according to claim 1, wherein said brazing material is at least partially in the form of a brazing foil.

3. The joining material according to claim 1, wherein said brazing material is at least partially in the form of brazing material grains.

4. The joining material according to claim 1, which further comprises a first adhesive fixing said brazing material on said carrier material.

5. The joining material according to claim 4, which further comprises a second adhesive disposed on a side of said brazing material facing away from said carrier material.

6. The joining material according to claim 5, wherein said first and second adhesives produce first and second respective forces, and said first adhesive force is greater than said second adhesive force.

7. The joining material according to claim 5, which further comprises a third adhesive disposed on a side of said carrier material facing away from said brazing material.

8. The joining material according to claim 1, wherein said carrier material is formed of at least one material selected from the group consisting of metal, plastic and paper.

9. The joining material according to claim 1, wherein said brazing material has a melting point, said carrier material has a critical temperature above which said carrier material is destroyed, and said critical temperature is at most equal to said melting point of said brazing material.

10. The joining material according to claim 9, wherein said carrier material is at least partially evaporated and/or at least partially decomposed upon at least reaching said critical temperature.

11. The joining material according to claim 9, wherein said carrier material is evaporated substantially without leaving any residues and/or decomposed substantially without leaving any residues upon at least reaching said critical temperature.

12. A process for producing a honeycomb body with a honeycomb structure having cavities through which a fluid can at least partially flow, the process comprising the following steps:
A) providing at least one at least partially metallic layer;
B) positioning brazing material at least on joining regions of the at least one at least partially metallic layer, at least partially in the form of at least one of the joining material according to claim 1 or a brazing foil adhesively bonded on at least one of the joining regions;
C) forming the honeycomb structure from the at least one at least partially metallic layer; and
carrying out a brazing operation.

13. The process according to claim 12, which further comprises:
D) providing a tubular casing;
E) positioning brazing material on at least one of an attachment region of an outer surface of the honeycomb structure or an inner surface of the tubular casing, at least partially in the form of at least one of the joining material according to claim 1 or a brazing foil adhesively bonded on the at least one attachment region; and
F) introducing the honeycomb structure into the tubular casing.

14. The process according to claim 12, which further comprises cutting the brazing foil to dimensions of at least one of the joining regions prior to or during step B).

15. The process according to claim 12, which further comprises joining the brazing foil to the carrier material.

16. The process according to claim 12, which further comprises providing the at least one at least partially metallic layer in step A) as at least one at least partially structured layer.

17. The process according to claim 12, which further comprises providing the at least one at least partially metallic layer in step A) as at least one substantially smooth layer.

18. The process according to claim 16, which further comprising:
providing the at least one at least partially structured layer with a structuring having a characteristic distance between two adjacent structure extremes in a transverse direction of the structuring; and
providing at least some of the joining regions, in a transverse direction of the structuring, with an extent being greater than the characteristic distance.

19. The process according to claim 18, wherein the characteristic distance is a wavelength.

20. The process according to claim 18, wherein a quotient of the characteristic distance and the extent is substantially between 1.2 and 5.

21. The process according to claim 18, wherein a quotient of the characteristic distance and the extent is substantially between 1.5 and 3.

22. The process according to claim 18, wherein a quotient of the characteristic distance and the extent is substantially between 1.8 and 2.5.

23. The process according to claim 12, which further comprises providing the at least one at least partially metallic layer as a substantially smooth layer, and applying at least one of the brazing material or the joining material to the substantially smooth layer.

24. The process according to claim 12, which further comprises providing the at least one at least partially metallic layer as an at least partially structured layer, and applying at least one of the brazing material or the joining material to the at least partially structured layer.

25. The process according to claim 12, which further comprises providing the at least one at least partially metallic layer as at least one substantially smooth layer and at least one at least partially structured layer having dimensions, and providing the carrier material with dimensions substantially at least partially corresponding to the dimensions of at least one of the layers.

26. The process according to claim 12, which further comprises fixing at least one of the joining material or the brazing material to the at least partially metallic layer in step B).

27. The process according to claim 13, which further comprises fixing at least one of the joining material or the brazing material to at least one of an outer surface of the honeycomb structure or an inner surface of the tubular casing in step E).

28. The process according to claim 13, which further comprises fixing at least one of the joining material or the brazing material to the at least partially metallic layer in step B) and to at least one of an outer surface of the honeycomb structure or an inner surface of the tubular casing in step E).

29. The process according to claim 12, which further comprises applying an adhesive to at least one of the brazing material or the carrier material before or during process step B).

30. The process according to claim 13, which further comprises applying an adhesive to at least one of the brazing material or the carrier material before or during process step B) or E).

31. The process according to claim 12, which further comprises forming the joining regions on both longitudinal sides of the at least partially metallic layer, but forming a joining region on only one longitudinal side of the at least partially metallic layer at a given coordinate.

32. The process according to claim 31, which further comprises producing the joining regions in at least two subregions in a longitudinal direction of the honeycomb body, and providing a longitudinal side of the at least partially metallic layer with the joining regions in only one of the subregions.

33. The process according to claim 32, which further comprises forming each of the subregions in vicinity of or adjacent an end side of the honeycomb body.

34. The process according to claim 32, which further comprises providing another subregion centrally within the honeycomb body substantially in the longitudinal direction.

35. A honeycomb body, comprising:
a honeycomb structure having at least one at least partially metallic layer defining cavities through which a fluid can at least partially flow; and
brazing material being positioned or adhesively bonded as a brazing foil in joining regions by the joining material according to claim 1;
said at least one layer being brazed to at least one of itself or an adjacent layer only in said joining regions.

36. The honeycomb body according to claim 35, which further comprises a tubular casing surrounding said honeycomb structure, said at least one layer being brazed to said tubular casing only in attachment regions, and said brazing material being positioned or adhesively bonded as said brazing foil in at least some of said attachment regions by the joining material.

37. The honeycomb body according to claim 35, which further comprises a honeycomb body diameter of at least substantially 150 mm.

38. The honeycomb body according to claim 35, wherein said at least one layer has two longitudinal sides, said joining regions are present on both of said longitudinal sides, and said joining regions are present on only one of said longitudinal sides at a given coordinate.

39. The honeycomb body according to claim 38, which further comprises at least two subregions disposed in longitudinal direction and having said joining regions, each of said longitudinal sides of said at least one layer having said joining regions only in one of said subregions.

40. The honeycomb body according to claim 39, wherein each of said subregions is formed in vicinity of or adjacent a honeycomb body end side.

41. The honeycomb body according to claim 39, which further comprises another subregion formed centrally within the honeycomb body substantially in said longitudinal direction.

42. A honeycomb body, comprising:
a honeycomb structure having at least one at least partially metallic layer defining cavities through which a fluid can at least partially flow;
a tubular casing surrounding said honeycomb structure;
brazing material being positioned or adhesively bonded as a brazing foil in attachment regions by the joining material according to claim 1; and
said at least one layer being brazed to said tubular casing only in said attachment regions.

43. A motor vehicle, comprising at least one honeycomb body according to claim 35.

44. A motor vehicle, comprising at least one honeycomb body produced by the process according to claim 12.
